(19) United States
(12) Patent Application Publication
(10) Pub. No.: US 2015/0278162 A1
(43) Pub. Date: Oct. 1, 2015

(54) RETENTION OF CONTENT IN CONVERTED DOCUMENTS

(71) Applicant: ABBYY Development LLC, Moscow (RU)

(72) Inventors: Ivan Yurievich Korneev, Moscow (RU); Sergey Georgievich Popov, Moscow (RU); Alexander Sergeevich Makushev, Moscow (RU); Natalia Kolodkina, Moscow (RU)

(21) Appl. No.: 14/570,088

(22) Filed: Dec. 15, 2014

(30) Foreign Application Priority Data
Mar. 31, 2014 (RU) 2014112236

(51) Int. Cl. G06F 17/21; G06K 9/18; G06K 9/00; G06F 17/30

(52) U.S. Cl. CPC G06F 17/212; G06F 17/30371; G06F 17/30011; G06F 17/30424; G06K 9/18; G06K 9/00483

(57) ABSTRACT

For lossless conversion of a PDF document to searchable PDF document, the PDF document is received. The PDF document has a potential first text layer. An evaluation of quality of the first text layer is performed. The first text layer is determined to be nonexistent or unacceptable. A text recognition of the document is performed to generate a second text layer. The second text layer is made to be used for searching or copying.

### CROSS REFERENCE TO RELATED APPLICATIONS

This application claims the benefit of priority to Russian Patent Application No. 2014112236, filed Mar. 31, 2014; disclosure of which is incorporated herein by reference in its entirety.

### BACKGROUND OF THE INVENTION

1. Field of the Invention

The present invention pertains in general to the field of image processing, specifically, a way to process documents through conversion mechanisms using Optical Character Recognition technologies (OCR) without data loss.

2. Description of the Related Art

Optical Character Recognition (OCR) systems are widely used. In an OCR system, as most errors occur at a character recognition stage, accuracy of recognition of individual characters is a pivotal factor. In order to achieve greater OCR accuracy, the number of errors in recognizing individual characters must be minimized.

In today's society, document portability across platforms has become increasingly important. For example, documents containing images may be converted from a particular file format into another file format as, for example, the document is exported to searchable file format for storage, to be emailed or to be shared with social network contacts for reviewing and annotation, and the like. The maximization of the efficiency of such conversion while, as in OCR processes, minimizing errors and information loss is highly advantageous.

### SUMMARY OF THE DESCRIBED EMBODIMENTS

With the proliferation of document portability, there is a continuing and increasing need to efficiently convert documents, particularly those containing images, between formats while preserving the document integrity and minimizing the loss of information associated with the document pursuant to the conversion. Moreover, a continuing need exists to promote greater searchability of such documents and related information to improve productivity and otherwise enhance utility to the user, for example.

To address these needs, among others, various embodiments for effecting lossless conversion to PDF-type document are provided. In one such embodiment, by way of example only, the PDF-type document having a potential first text layer is received. An evaluation of quality of the first text layer is performed. The first text layer is determined to be nonexistent or unacceptable. A text recognition of the document is performed to generate a second text layer. The second text layer is made to be used for searching or copying.

In addition to the foregoing embodiment, other exemplary system and computer program product embodiments are provided and supply related advantages.

The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1A is a first illustration of a conversion process to searchable PDF format, in which, during the conversion process, various information is lost; specifically FIG. 1A shows a PDF-Image type document before the conversion process;

FIG. 1AA illustrates the same document as in FIG. 1A, but after the conversion process in which annotation information (specifically, for example, text boxes) contained in the PDF-Image document shown in FIG. 1A is lost;

FIG. 1B illustrates a PDF-Image+Text (searchable PDF) document having such annotation information as text or comment boxes, watermarks, and notes, before the conversion process;

FIG. 1BB illustrates the same document as in FIG. 1B, but after the conversion process in which the annotation information contained in the document is lost;

FIG. 1C illustrates a PDF Normal document having such information as text or comment boxes, images, and notes, before the conversion process, specifically where the image information contained therein is vector information;

FIG. 1CC illustrates the same document as in FIG. 1C, but after the conversion process in which the original text got lost; the text or comment boxes, and notes are lost, and the image information is converted into raster graphics;

FIG. 1D illustrates a PDF document where the text is represented in the form of curves having such information as text boxes and vector graphics images before the conversion process;

FIG. 1DD illustrates the same document as in FIG. 1D, but after the conversion process in which the original text got lost and the vector graphics images have been converted to raster graphics images;

FIG. 2 is a flow chart diagram of an exemplary flow chart method for efficient, lossless conversion of documents into searchable form, in which aspects of the present invention may be implemented;

FIG. 3 is an additional flow chart diagram of an additional exemplary flow chart method for efficient, lossless conversion of documents into searchable form, here again in which aspects of the present invention may be implemented;

FIG. 4A is a first illustration of a conversion process to searchable PDF format according to one exemplary embodiment of the present invention, in which, during the conversion process, various information is retained; specifically FIG. 4A shows a PDF-Image type document before the conversion process;

FIG. 4AA illustrates the same document as in FIG. 4A, but after the conversion process in which annotation information (specifically, for example, text boxes) contained in the PDF-Image document shown in FIG. 1A is retained;

FIG. 4B illustrates a PDF-Image+Text (searchable PDF) document having such annotation information as text or comment boxes, watermarks, and notes, before the conversion process in an additional exemplary embodiment of the present invention;

FIG. 4BB illustrates the same document as in FIG. 4B, but after the conversion process, again according to the additional embodiment of the present invention, in which the annotation information contained in the document is retained;

FIG. 4C illustrates a PDF Normal document having such information as text or comment boxes, images, and notes, before the conversion process in a third exemplary embodiment of the present invention, specifically where the image information contained therein is vector information;

FIG. 4CC illustrates the same document as in FIG. 4C, but after the conversion process, again according to the third embodiment of the present invention, in which the original text, text boxes, comment boxes, and notes are retained, and the image information is retains vector graphics;

FIG. 4D illustrates a PDF document with text presented in the form of curves having such information as text boxes, vector text and vector graphics images before the conversion process in a fourth exemplary embodiment; and

FIG. 4DD illustrates the same document as in FIG. 4D, but after the conversion process of the fourth embodiment in which the original text and vector graphics images are retained.

### DETAILED DESCRIPTION OF THE DRAWINGS

As previously mentioned, a continuing need exists for an efficient mechanism for converting documents to an appropriate format for a particular situation, for example for storage with particular properties. It is highly desirable that, on the one hand, the selected format provide an automatic search for a word or phrase in the text and further provide high quality visualization both graphical and textual data; on the other hand it is also desirable that the appropriate format file exhibit a compact size. These requirements are attempted to be satisfied, in one embodiment, by use of so-called Portable Document Format (PDF) format.

PDF format is a popular format for document exchange. However, not all the PDF documents, which were obtained from different originals (e.g., received from colleagues or downloaded from the Internet or produced by scanning), have properties suitable for storage. Each PDF file is unique. File properties and actions that can be performed with it depend on the program in which it was created. Therefore, for example, in some PDF-files, text-based search and copying can be easily performed, whereas in the other search and copying are not available to a user. Also there are numerous PDF-files where search and copying seem to be available, but errors occur in attempt to search or copy. For example, the word may not be found (does not appear in the search results), although it is present in the document. Instead of the copied characters, a number of irrelevant and/or unreadable characters may result, such as Mojibake.

One possible way to address the above issue is to re-recognize the document using OCR technology. However, during recognition, some information often is lost from the documents. For example, the original text (the original text is replaced by the recognized text) may be lost, comments may disappear, bookmarks of the previous reviewer may vanish, and quality vector graphics may be replaced by raster graphics.

Vector graphics are formed by objects: graphics primitives (point, line, circle, rectangle, etc.) that are stored in the computer memory in the form of mathematical formulas that describe them. For example, a point is defined by its coordinates (X, Y), and the line is defined by the beginning (XI, Y1) and end (X2, Y2) coordinates. In contrast, an associated raster image is a dot matrix data structure representing a generally rectangular grid of pixels, or points of color, viewable via a monitor, paper, or other display medium.

The advantage of vector graphics in comparison with raster graphics is that files containing vector graphics have a relatively small size, whereas raster graphics require a high amount of disk space. Additionally vector graphics can be enlarged or reduced without a loss in quality; that cannot be said about raster graphics.

In some cases, when converting documents from PDF and Tagged Image File Format (TIFF) file format to PDF file format to perform the search, the loss of quality is critical.

In addition to PDF format for document exchange, TIFF format is often used. Documents in TIFF format implement a raster graphic image. Other examples of documents types that are merely images also exist. For example, a photograph that was produced using a digital camera may be stored in JPEG format, PNG format, BMP format, RAW format, and so forth. Image file formats, in turn, have a significant disadvantage when they are used for storage; namely such kind of file formats do not provide the possibility for text-based search in the document without the preliminary recognition of documents. Moreover, storage of image files necessitates the use of a large amount of disk space.

In one embodiment, the mechanisms of the present invention describe a special mode of converting (converting data from one format to another) different types of documents (e.g., PDF, TIFF format) to Searchable PDF format without quality and with a smaller file size.

In most PDF files and each TIFF file, text-based search and copying aren't possible without preliminary recognition. Often when documents are recognized, the original quality of documents are lost.

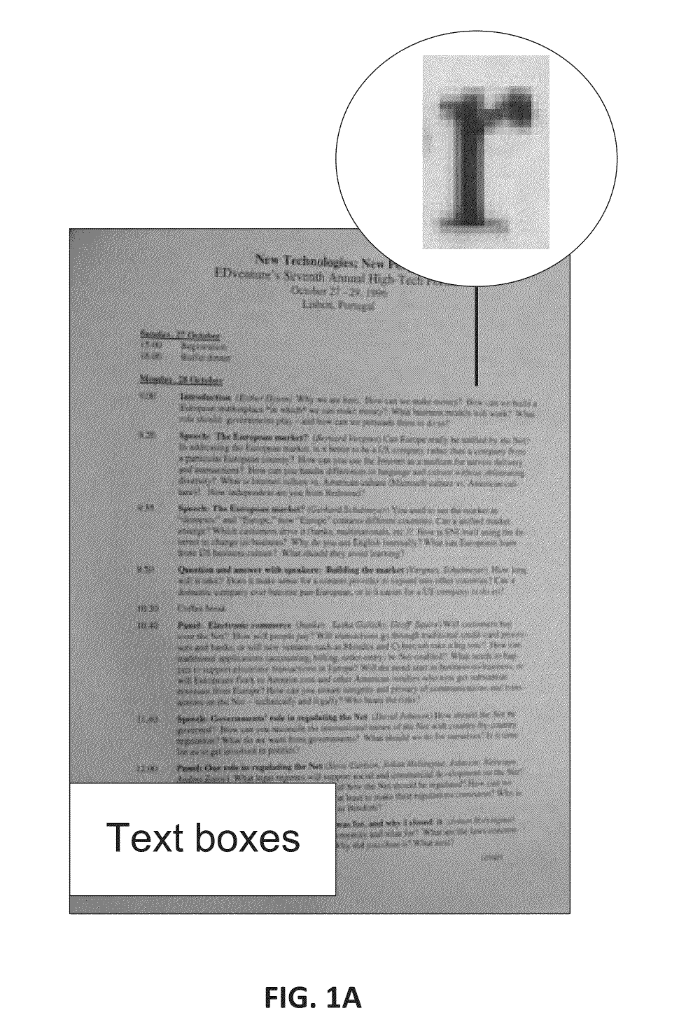

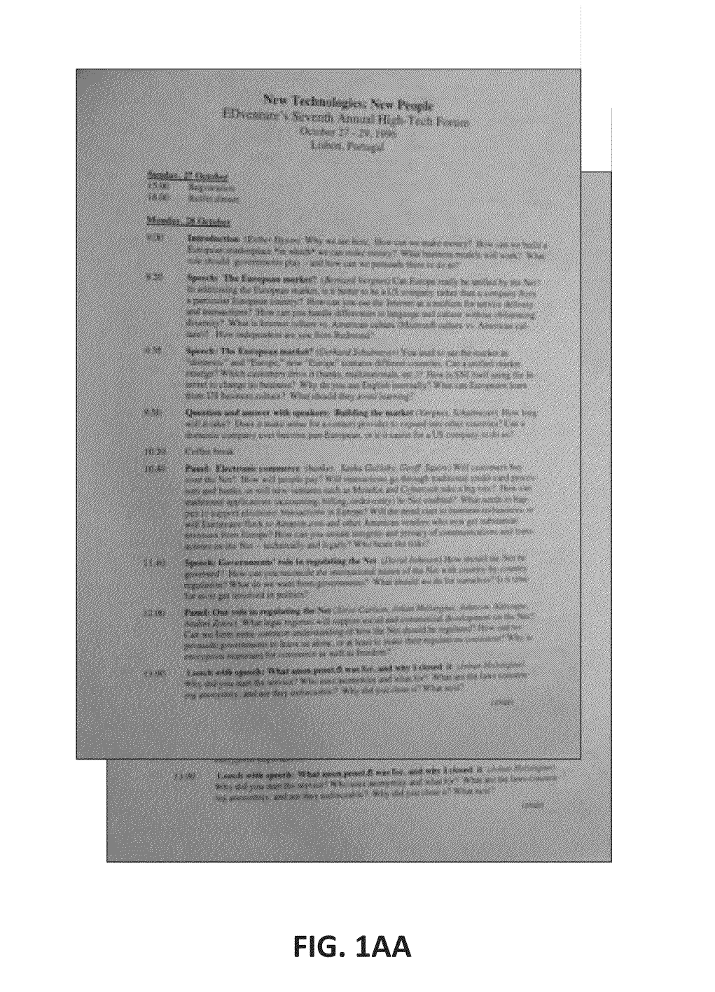

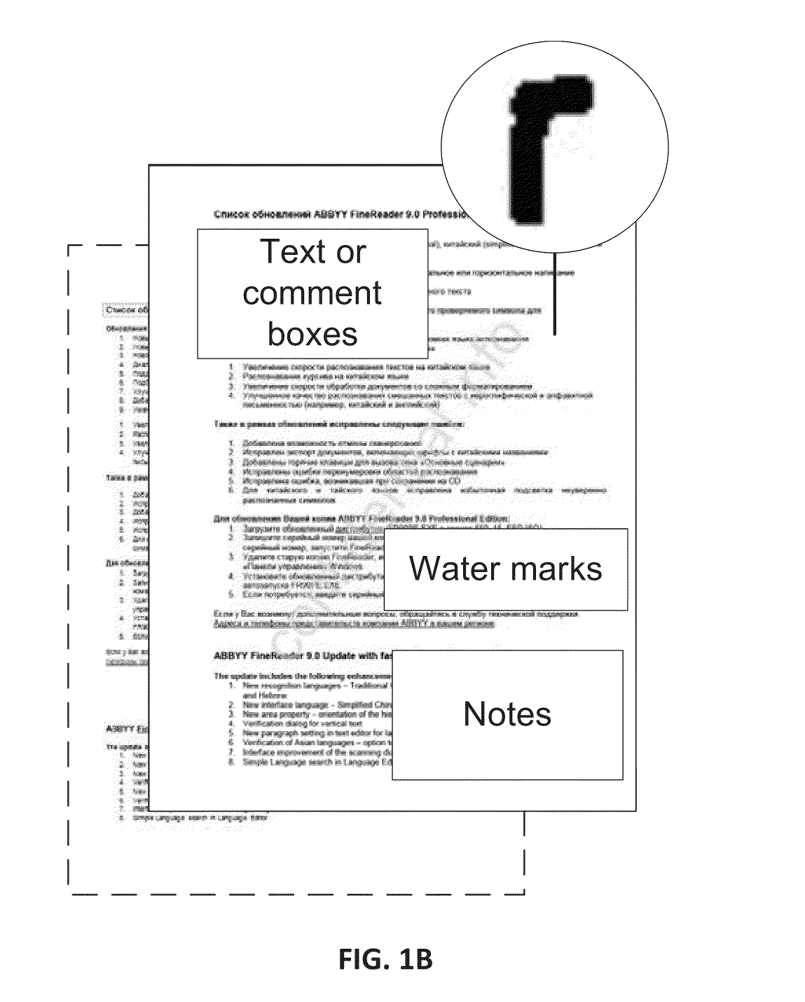

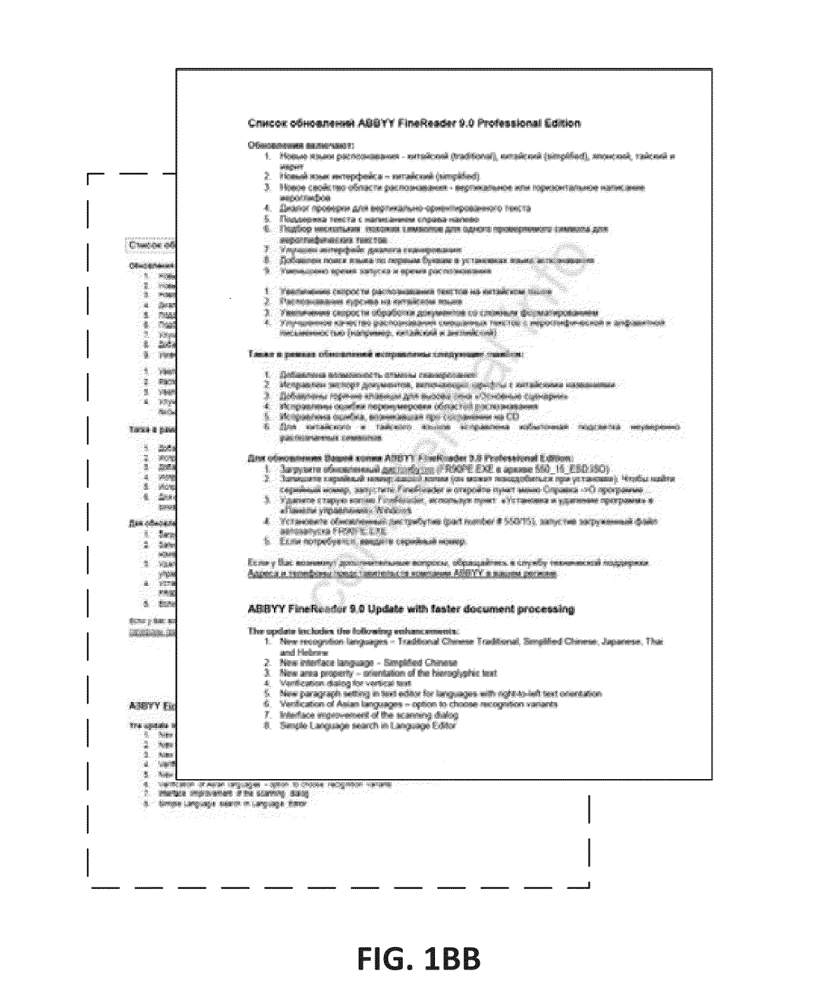

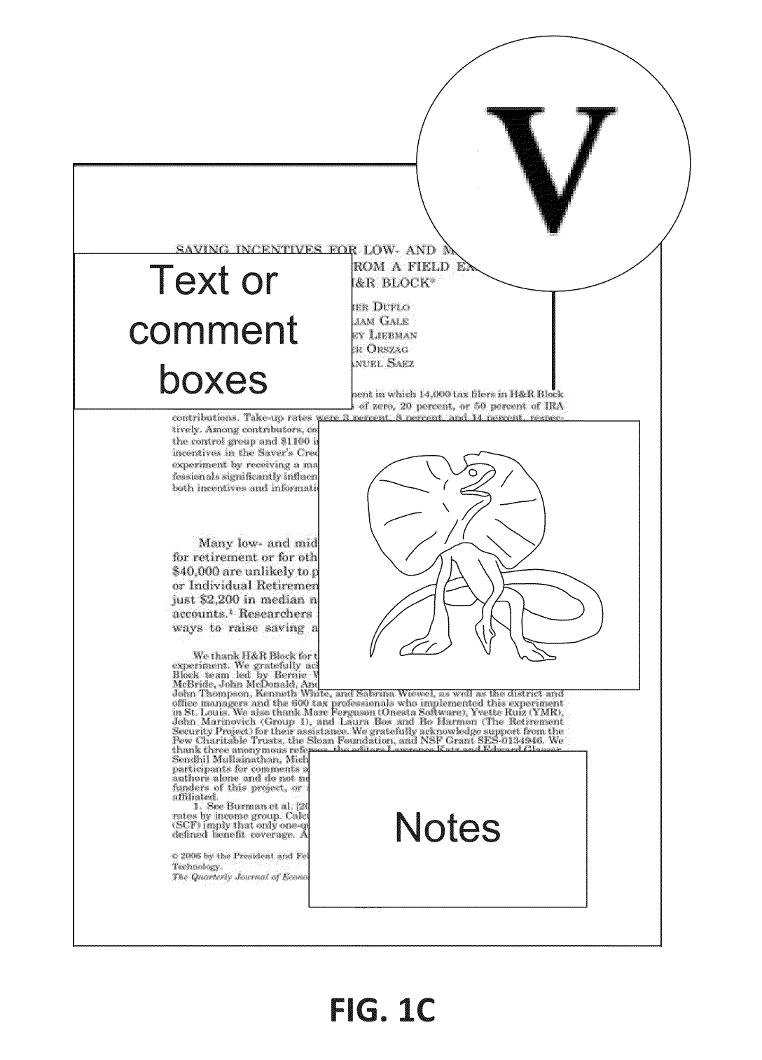

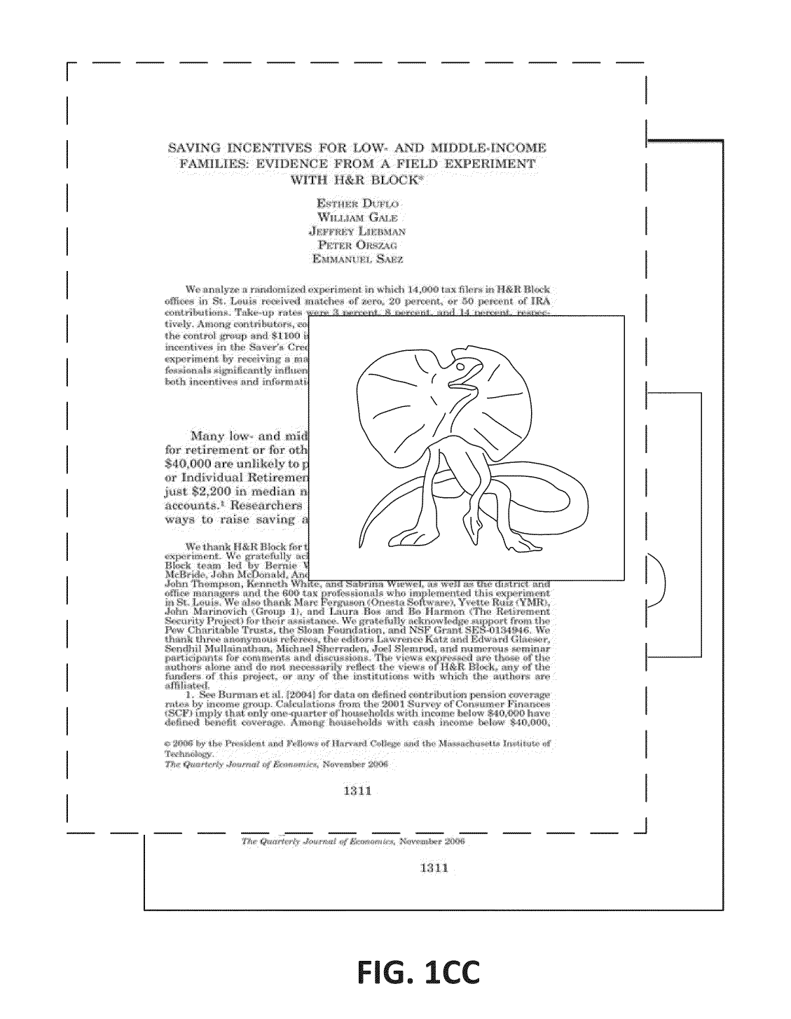

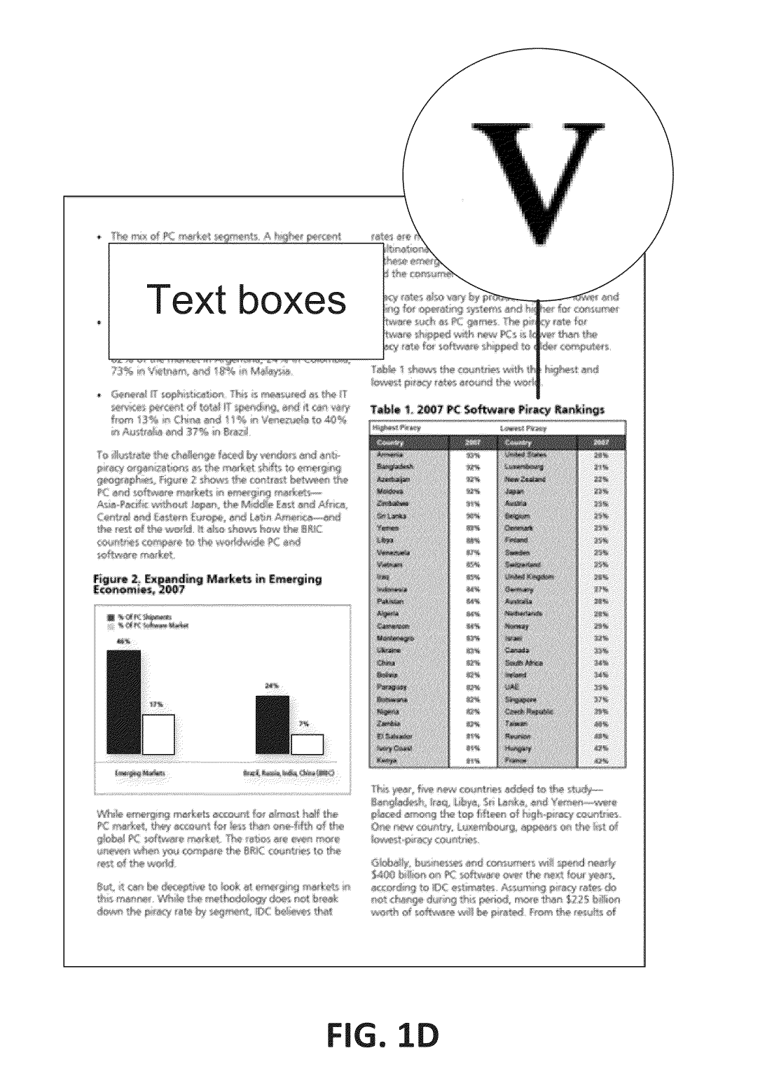

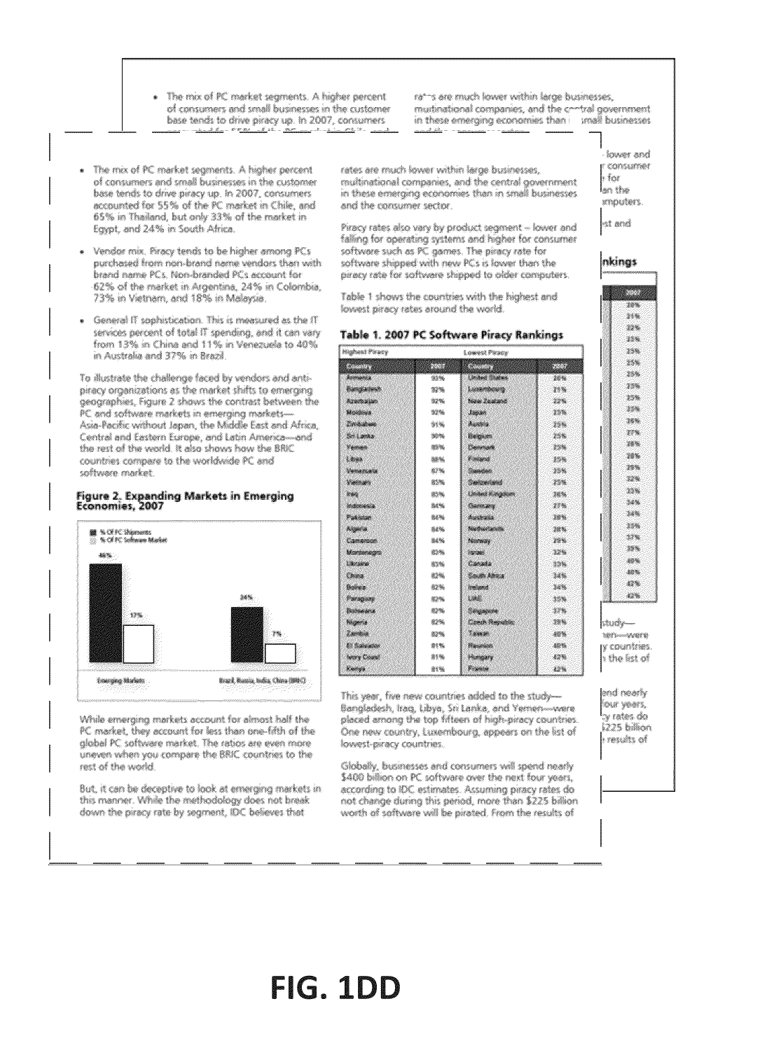

FIGS. 1A-1DD, following, illustrate examples of converting various types of PDF documents to searchable PDF format, using a standard recognition process. As a result of the given operation in PDF Image (image only) (1A) and PDF Image+Text (searchable PDF) (1B) types of documents all annotations are lost (1AA, 1BB).

Use of the terminology “annotations” in this context may be understood to refer to, for example, items that are displayed on the page of the document, but are not part of the document's content: comments, notes in the text (underline, strikethrough, selecting by marker), etc.

In PDF Normal (normal PDF obtained by printing to a virtual printer, for example from MS Word, Excel, etc.) (1C) and PDF Vector (the type of PDF files wherein the text is presented in the form of curves obtained with a vector graphics editor) (1D) types of documents the original text and all annotations are lost, as well as vector graphics are replaced by raster graphics (1CC, 1DD). Replacement the original text by the recognized text is undesirable because it can lead to errors in the text (e.g., due to the fact that certain characters may be recognized incorrectly) and loss of visual quality (for example, due to the fact that the font originally used in PDF file was replaced by another font because of lack of original one on the user's PC).

Turning now to these illustrations, FIG. 1A is a first illustration of a PDF conversion process, in which, during the conversion process, various information is lost. Specifically FIG. 1A shows a PDF-Image format document before the conversion process. As a following step, FIG. 1AA illustrates the same document as in FIG. 1A, but after the conversion process in which annotation information (specifically, for example, text boxes) contained in the PDF-Image document shown in FIG. 1A is lost.

FIG. 1B, following, illustrates a PDF-Image+Text (searchable PDF) document having such annotation information as text or comment boxes, watermarks, and notes, before this conversion process. In a following step, FIG. 1BB illustrates the same document as in FIG. 1B, but after the conversion process in which the annotation information contained in the document shown in FIG. 1B is lost.

FIG. 1C, following, illustrates a PDF Normal document having such information as text or comment boxes, images, and notes, before the conversion process, specifically where the image information contained therein is vector information. In a following step, FIG. 1CC illustrates the same document as in FIG. 1C, but after the conversion process in which the text or comment boxes, and notes got lost, and the image information is converted into raster graphics of lower quality.

Finally, FIG. 1D illustrates a PDF document with text presented in the form of curves having such information as text boxes, vector text and vector graphics images before the conversion process; while FIG. 1DD illustrates the same document as in FIG. 1D, but after the conversion process in which the original text is lost, text boxes got lost and the vector graphics images have been converted to raster graphics images.

To address the foregoing loss and other issues previously mentioned, mechanisms of the present invention, in one embodiment, describe a special mode of converting the documents to searchable format (such as, for example, searchable PDF) while keeping the original document quality. By “original quality” of the document as used herein, in one embodiment, original quality may be understood as keeping of the original document appearance (the graphics) and information, including bookmarks, comments, etc.

To address these issues as previously described, various methodologies for implementing aspects of the present invention are currently proposed. As a first step, for example, a PDF-type document is received. Then the document may be converted to a searchable format (e.g., searchable PDF) while retaining the original quality, namely, for example, the original PDF pages (the graphics) and information. During the converting, the document may be reviewed for the existence of any “text layer” in any form. The “text layer” in one embodiment, may refer to an area of the file that contains (fully or partially) the text found in the document. Implementation and use of a text layer provides the ability for a user to search and copy the text in the document.

In one embodiment, if the mechanisms of the present invention determine that the original document does not contain a text layer, the text layer is added. If the original document already contains a text layer (referred to as “a first text layer” below), the quality of the first text layer is examined. If the first text layer is found to be of suspect quality, the first text layer may be replaced by a second text layer of higher quality. Reference to a text layer of “bad quality,” as used herein, may indicate any text layer that generates errors during the text-based search and copying from a document to a text editor. When the text layer is added or replaced, the appearance of the document doesn't change, because the text layer is added “behind” or “underneath” the image of the document. In addition, all bookmarks, comments and the like remain untouched (not destroyed) if the original document contains them. Additionally the described mode of converting allows for compression the original image of document without a loss in quality by explicit user command. As a result, a text-searchable document is output from the conversion process that does not exhibit a loss in visual quality of the original document and related information.

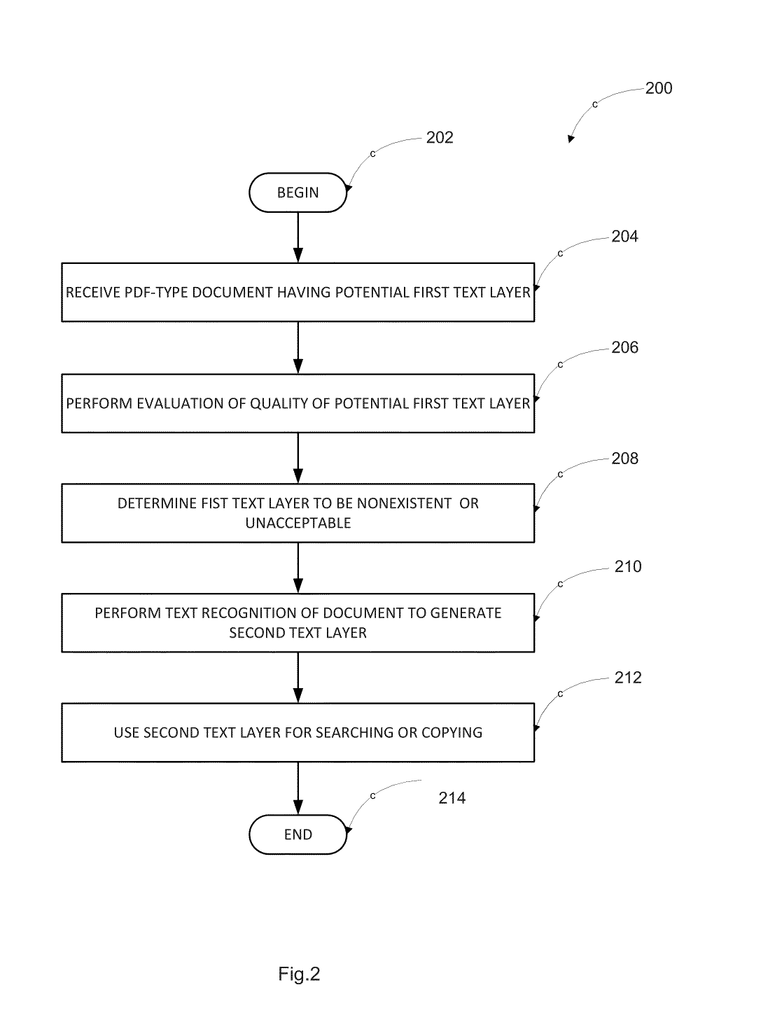

FIG. 2, following, shows a general flow chart for a method 200 of replacing the first text layer with the second text layer if the first text layer is found to contain errors in accordance with one of the embodiments of the present invention. Method 200 begins (step 202) with the receipt of the PDF-type document having a potential first text layer (step 204). Then an evaluation of quality of the first text layer is performed (step 206). Depending on the evaluation of quality, the first text layer may be determined to be unacceptable (step 208). If so, the first text layer may be made inoperable for searching or copying functions

In a following step, a text recognition process (e.g., OCR) is performed on the document (like on the image) to generate a second text layer (step 210). The generated second text layer is used for searching and copying (step 212). The method 200 then ends (step 214).

Notably in the case of PDF files, there are several basic types of PDF documents, or PDF-types. The first type is PDF (Image only). PDF Image documents contain only the image of the page and do not contain a text layer (FIG. 1A). This type can be obtained by scanning or photographing the document and saving the results in PDF format. It may often be difficult to work with such types of PDF-files, because of the lack for a text layer a search and coping of the text are not available in such documents.

The second type of PDF document is PDF Normal (or True PDF, or Real PDF). PDF Normal documents contain only a text layer (FIG. 1B). This type of PDF document is obtained by converting the edited files (MS Word, Excel, PowerPoint) to PDF-format. In the second type of PDF files, the text or image can be easily copied, and a text-based search is possible.

The third type of PDF document is Searchable PDF (or PDF Image+Text). These are PDF documents that are a compromise between the first and second types of PDF files, which described above. Searchable PDF is a result of the recognition process of PDF Image documents using Optical character recognition technologies (OCR). In such a document the image of the page is retained, and the recognized text is placed behind the image (FIG. 1C). Thus, in a document of this type, search and copying of the text are available, at the same time the appearance of PDF-document doesn't change compared to the original document. In such documents. search and copy results are dependent on the quality of the text layer, which can be different from the visible image of the page.

Finally, the fourth type is Vector PDF. PDF (Vector) format includes files containing vector text or files where the text is presented in the form of curves (FIG. 1D). These files are quite rare and can be created using vector graphics editors with indicating specific settings. Within these documents it is impossible to copy or search the text.

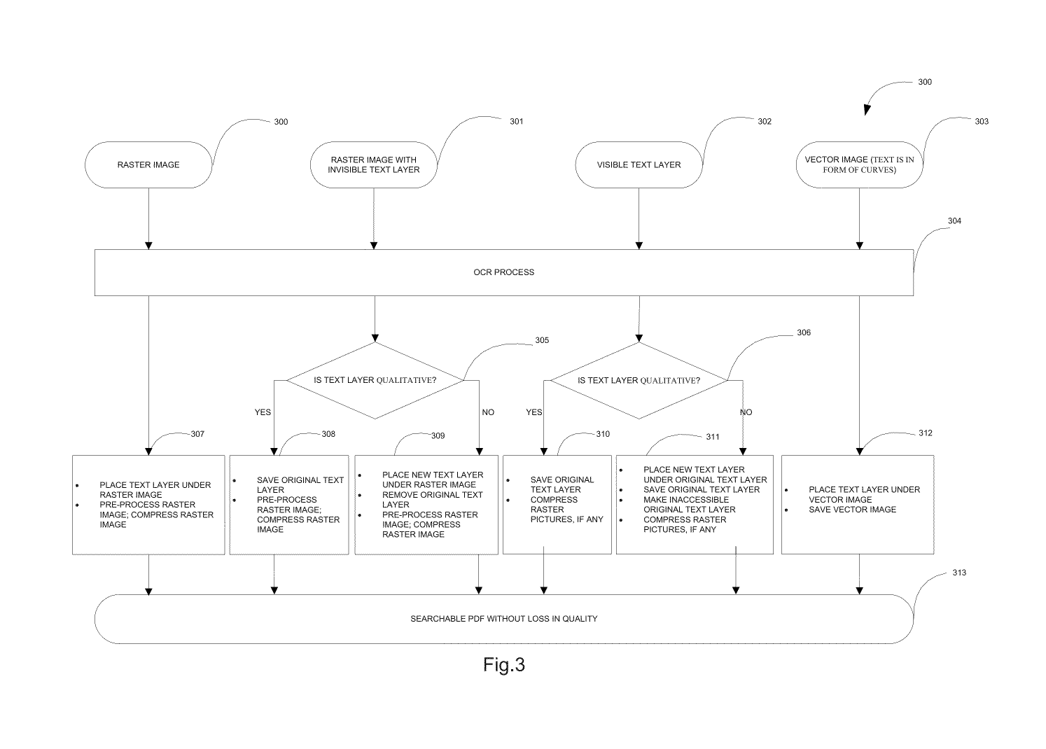

Several steps may be performed during the converting of the document. The steps are shown in FIG. 3, following by method 350, as an exemplary embodiment of efficient, lossless document conversion in which aspects of the present invention implemented. As input the system receives a document or document fragment of a certain type that contains a raster image (for example, TIFF or PDF Image) (step 300), or raster image and invisible text layer (for example, PDF Image+Text) (step 301), or visible text layer (for example, PDF Normal), or vector image (for example, PDF Vector, where text is presented in the form of curves) (step 303). The document is supplemented by a qualitative text layer to perform the search in the text. For this matter, the original document is recognized (like an image) using optical character recognition technologies (OCR) (step 304). The recognition process is run independently on whether or not the original document contains the text layer.

Optical character recognition (OCR) systems are used to transform images or representations of paper documents, for example document files in the Portable Document Format (PDF), into computer-readable and computer-editable and searchable electronic files. A typical OCR system consists of an imaging device that produces the image of a document and software that runs on a computer that processes the images. As a rule, this software includes an OCR program, which can recognize symbols, letters, characters, digits, and other units and save them into a computer-editable format—an encoded format.

As a result of the recognition process, the page is transformed from a set of graphic images into text symbols, and information is produced about the layout (coordinates) of the text and pictures in the original image, etc. This output may be stored in an additional text layer that is associated with the page.

If the original document or document fragment doesn't contain a text layer (for example, document type 300 or 303), then the additional text layer generated from the recognition process may then be added under the original image (steps 307 or 312). This additional text layer is the layer that may be subsequently utilized by a user for searching and copying purposes. Accordingly, the appearance of the document remains untouched.

If the original document or document fragment is represented in PDF format and it already contains a first text layer (document type/steps 301 or 302), the quality of the first text layer is checked (steps 305, 306). The first text layer is said to be qualitative when the search and copying of the text execute properly. The first text layer is not qualitative if the search and copying of the text execute improperly (for example, the word is not found (does not appear in the search results), although it is present in the document; instead, for example, of copied characters a number of unreadable characters or Mojibake (e.g., “ïÂÙËÎ” or “□ □ □ □ □ □ □”) are inserted). Errors can be related with incorrect coding of text in PDF.

In one embodiment, checking of the first text layer quality may be achieved by comparing the first text layer with the second text layer obtained as a result of recognition (again, step 304). This comparison can be performed due to the presence of information in the text layers about the location of the individual characters and words in the original image. Thus, to compare two text representations of the same document image, it is necessary to compare the word located at the same place on the original image (or having the same coordinates). If most of the words match, the first text layer doesn't contain errors, i.e. the first text layer is qualitative. If most of words don't match, the first text layer contains errors, i.e. the first text layer is not qualitative. If the first text layer is inadequate, then the second text layer may be made to be used for performing the text-searching and copying functionality mentioned previously.

In addition to the method described above, other embodiments may be implemented to check the text for errors. For example, original text, extracted from the PDF file, may be checked by dictionaries (perform dictionary validation). If the text doesn't contain errors, most of words in the text are contained in the dictionary.

In an additional embodiment, the errors in the text may also be identified by a Polygram method. According to this method, for example, all words in the text are divided into two or three-letter combinations (bigrams and trigrams). All received combinations are checked with using the table of their admissibility in the natural language. For example, the trigram <<qqq>> cannot exist in any English word. Similarly for the Russian language the trigram “TTT” cannot occur in any Russian word. If the wordform (the word in a certain grammatical form) does not contain an invalid polygram, then this wordform is considered correct, and otherwise—doubtful. If the text does not contain any errors, it contains many correct polygrams. So if the number of normal trigrams relative to total amount of trigrams found in the text greater than some threshold value, it may be said that the text does not contain errors. Alternatively, if the number of normal trigrams less than this threshold, then the text may be said to contain errors.

If the first text layer is qualitative, then the first text layer is retained (steps 308, 310). If the first text layer isn't qualitative, then the layer is replaced by the second text layer that was obtained as a result of the earlier recognition process (again, step 304). When the first text layer is replaced, a status of the first text layer may be taken into account. For example, the status may concern whether or not the layer is visible. If the first text layer is invisible, it is simply removed (step 309). If the first text layer is visible, it is retained and made inaccessible for search and copying. In this case the second text layer is placed under the first one (step 311). Thus, the appearance of the document remains unchanged.

In one embodiment, for preserving the visual quality the original image of the electronic document may be stored after the converting process.

Using the mechanisms of the illustrated embodiments, vector graphics remain intact. For example, if the original document is a vector PDF format, where the text is presented in the form of curves, in which search and copying of the text are not possible, then, as previously described, during the converting to searchable PDF the text layer may be added under the image of the text. Thus, in the document search and copying of the text become possible and at the same time the integrity of the appearance of the document is retained.

Raster graphics can be changed minimally in order to improve the quality of OCR and correctly match the text layer with the original image. Pre-processing of the original raster image is included in the process of recognition of the document (again, step 304). For the recognition system it is important that the image provided as input be of the highest possible quality. If the text is noisy (e.g., the text is on a background), not sharp (blurred, defocused), or has low contrast or other issues, then the task of its recognition become more complicated. Therefore, the image may undergo pre-processing in order to provide a high quality image for recognition. The pre-processing may include correction of the skewness of the lines (straightening the lines), selecting the orientation of the page (the system automatically determines the orientation of each page and corrects it if necessary, the page is turned 90, 180 or 270 degrees), filtering the noise from the image, increasing the sharpness and contrast of the image. Also, raster graphics can be compressed by a user request (again, steps 307, 308, 309, 310, 311) using compression technology of mixed raster content (Mixed Raster Content or MRC), which allows for the achievement of smaller file sizes without noticeable visual degradation.

Besides providing a search and retaining the visual quality of the document, this mode of converting to searchable PDF allows to transfer comments, notes and other annotations, left by a previous reviewer, from the source PDF file, as well as metadata (i.e. information about the document itself, such as author), compatibility with PDF/A format, etc.

PDF/A (a variety of PDF format) is a standardized format for long-term storage of documents in archive. PDF/A format ensures that the document, saved in this format, may be reproduced in its original form after years and decades. All the information, that is necessary for display the document at the same form every time, has to be implemented in a file. This includes (but not limits) all content (text, raster and vector graphics), fonts and color information, etc. Documents in PDF/A format cannot use information from external sources, for example, font programs, or hyperlinks.

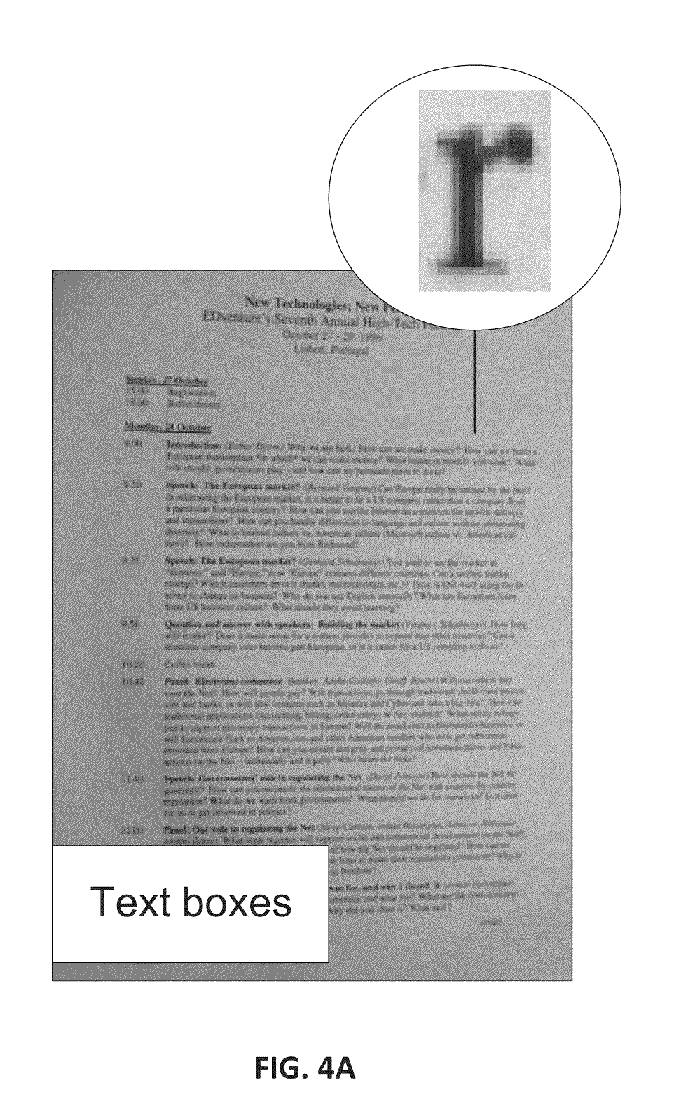

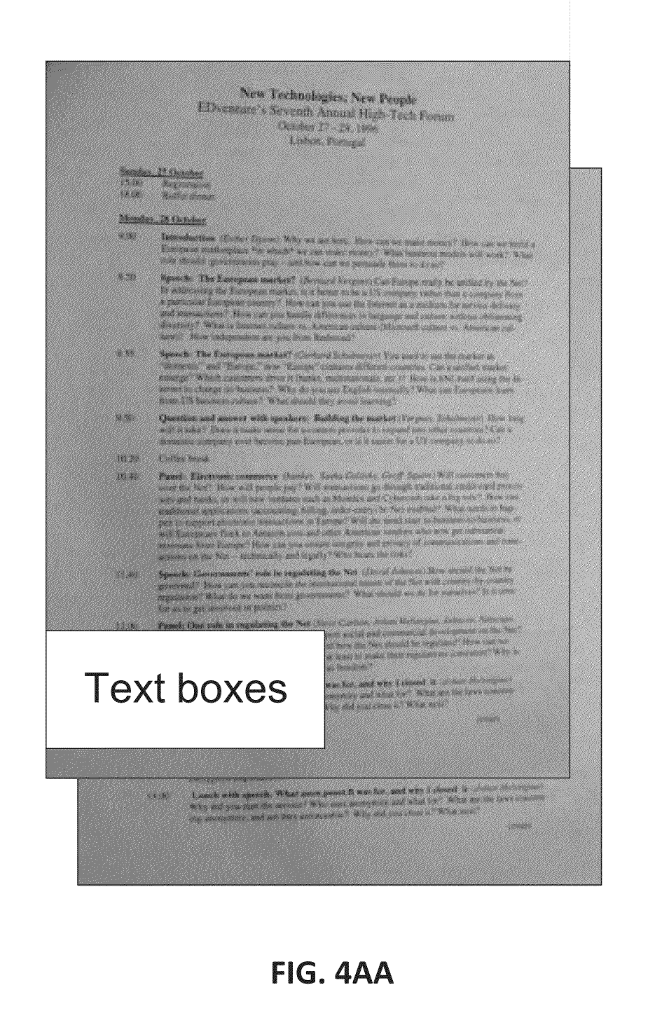

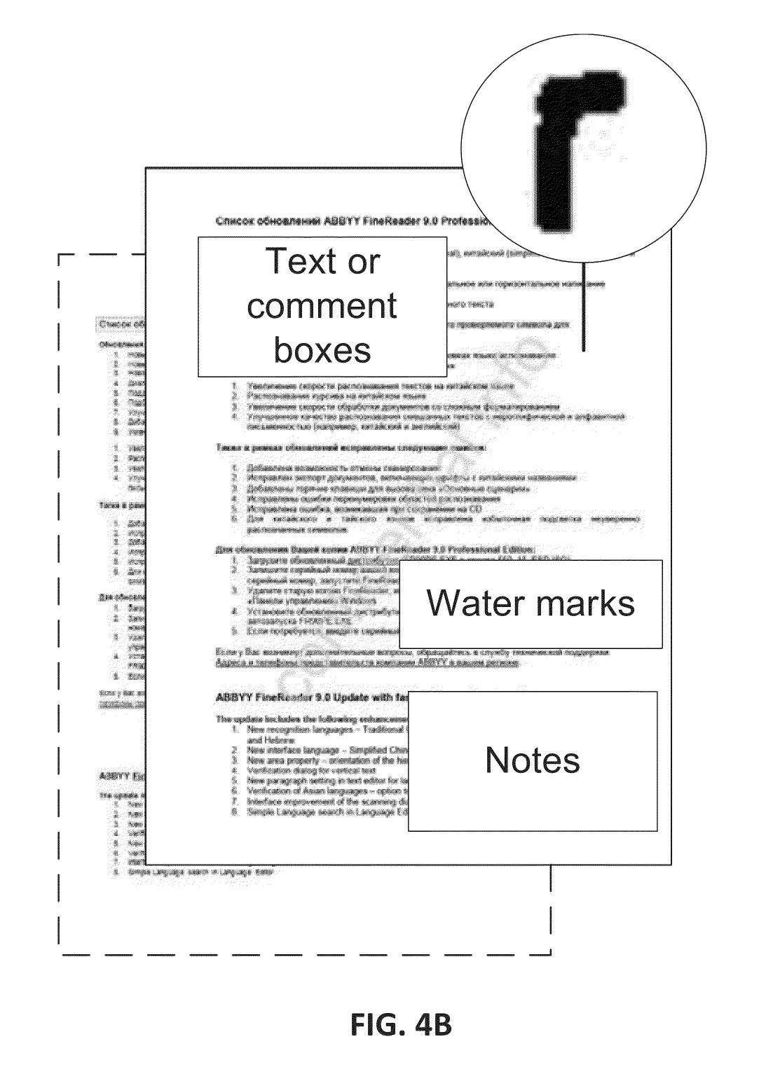

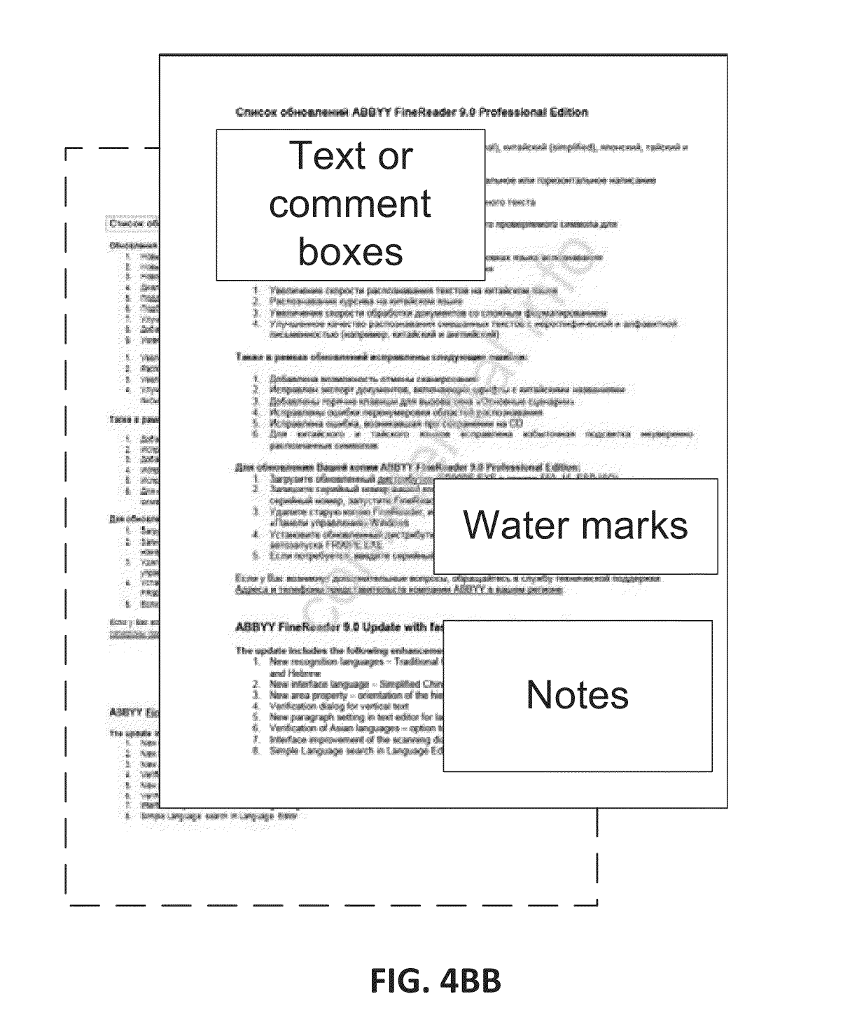

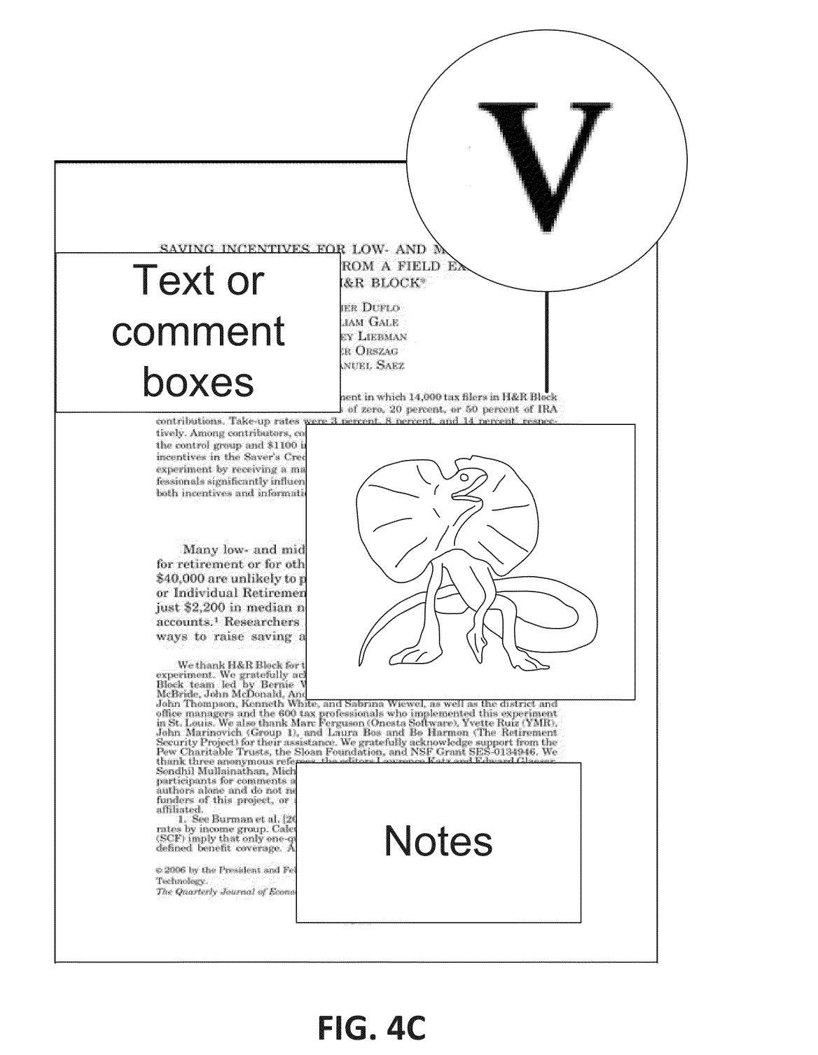

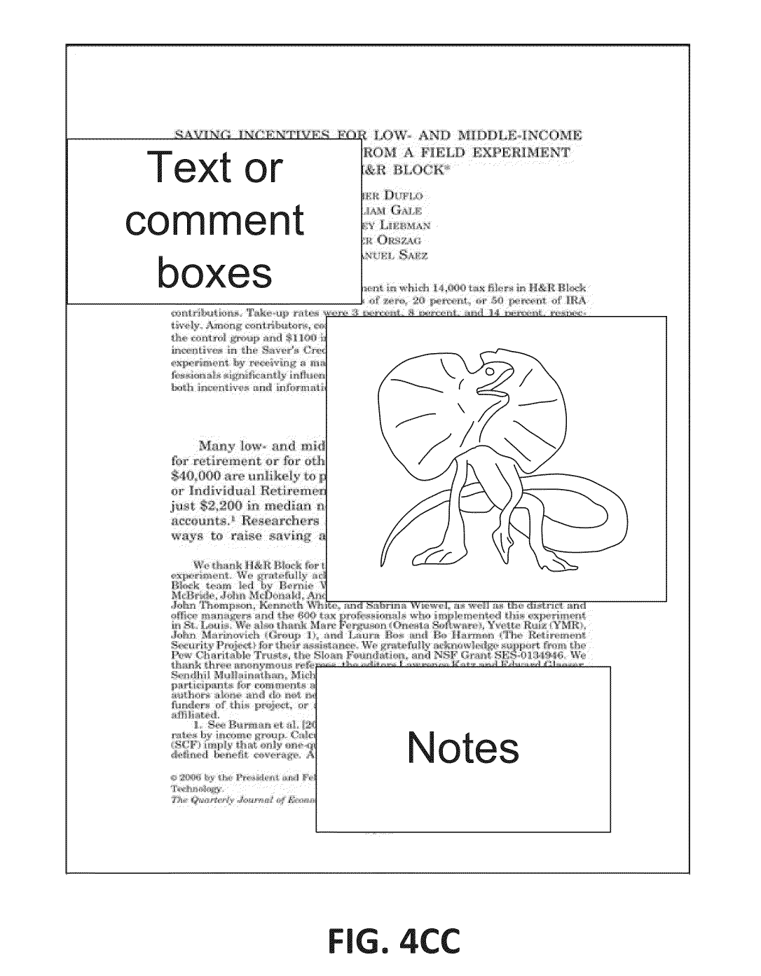

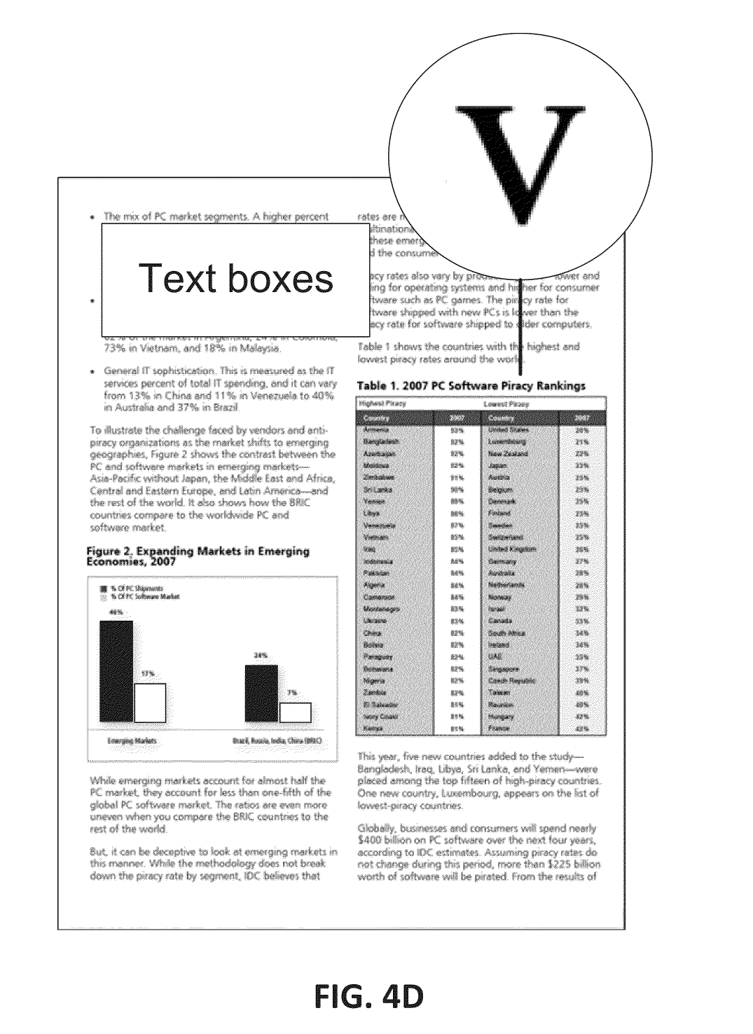

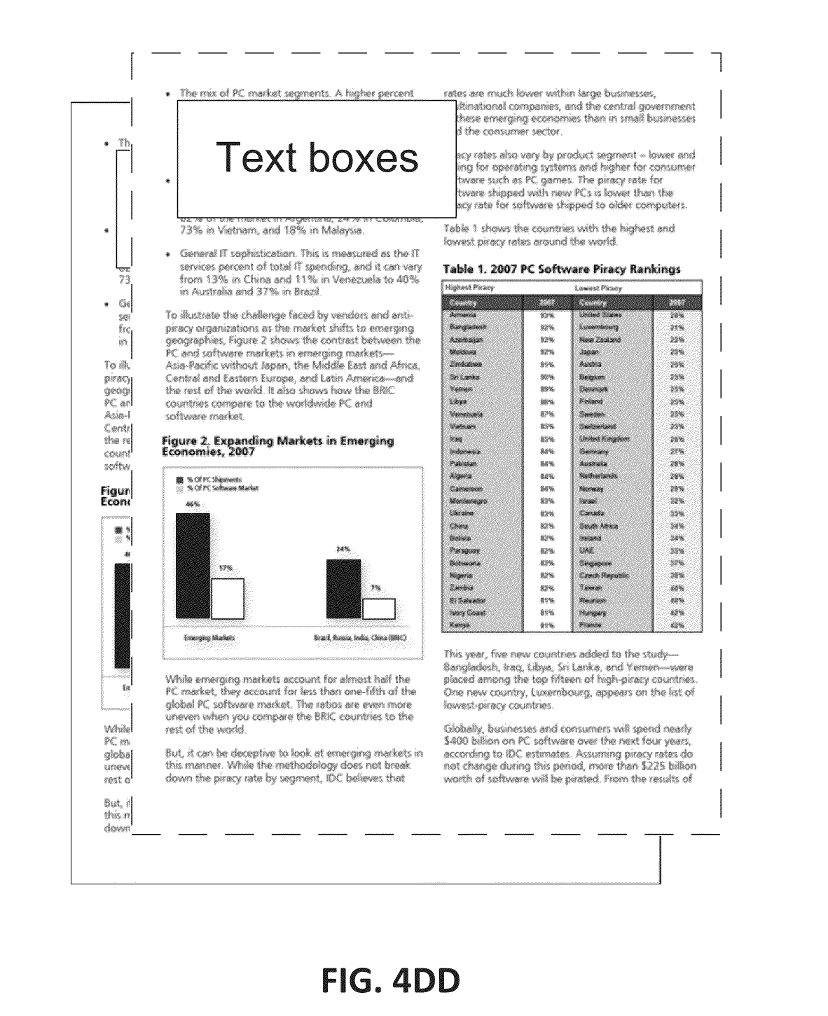

FIGS. 4A-4DD, following, illustrate examples of converting various types of PDF documents to searchable PDF, using various aspects of the illustrated embodiments. First, FIG. 4A illustrates a PDF Image document where, originally, a text layer was not found. In FIG. 4AA, following, the text layer has been added, and consequently, the text boxes annotations are retained through the conversion process as shown. Text boxes are important in PDF Image documents as they represent one of the few tools available to users for text editing in these kinds of documents.

Continuing with FIG. 4B, the illustrated PDF Image+Text document (searchable PDF) is shown. The existing text layer of this document is examined for quality, and in the case of quality lower than a predetermined threshold, the text layer is replaced and/or rebuilt by a more qualitative version. At the same time, comments, notes, watermarks and the like, which existed in the previous document 4B as shown are retained in FIG. 4BB, also as shown.

Turning now to FIG. 4C, a representative PDF Normal document is shown, again having an existing text layer. The text layer is examined for quality, and replaced or repaired if necessary, and consequently all vector graphics and other annotations are retained in the following FIG. 4CC as shown.

Finally, in FIG. 4D, an additional example representation of a PDF document is shown where the text is presented in the form of curves. Here, no text layer was originally present, and pursuant to the conversion process, a layer is added, thanks to which a search through the document becomes possible; while all annotations are retained as shown in the following FIG. 4DD.

Thus, as a result of the illustrated conversion processes in accordance with aspects of the present invention, documents are output without a loss in visual quality and the accompanying textual and graphical data, which compares with the original document undergoing the conversion (FIG. 3, step 313).

Aspects of the present invention will be useful for all institutions with a large document circulation: law firms, insurance companies, educational institutions, publishers, large industrial companies, government agencies, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the above figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

What is claimed is:

1. A method for lossless conversion of a PDF document to searchable PDF document using a processor device, comprising:
receiving a PDF document having a potential first text layer;
performing an evaluation of quality of the potential first text layer, wherein if the potential first layer does not exist or is not acceptable, a second text layer is generated for searching or copying.

2. The method of claim 1, wherein generating the second text layer comprises performing recognition of the document.

3. The method of claim 1 wherein the potential first text layer is not acceptable if it contains errors above a threshold.

4. The method of claim 1, wherein the first text layer is a visible text layer; and further comprising making the visible text layer inaccessible for searching or copying.

5. The method of claim 1, wherein the first text layer is an invisible layer; and further comprising removing the invisible text layer.

6. The method of claim 1, wherein the performing the evaluation of quality of the first text layer comprises comparing the first text layer with the second text layer.

7. The method of claim 6, wherein the comparing of the first text layer to the second text layer comprises comparing portions of the first text layer and the second text layer related to a same portion of the image.

8. The method of claim 1, wherein the performing the evaluation of quality of the first text layer comprises comparing the first text layer against at least one dictionary to perform a dictionary validation operation.

9. The method of claim 1, wherein the performing the evaluation of quality of the first text layer further comprises performing a Polygram method on the first text layer by:
dividing each word in the first text layer into letter combinations, where the letter combinations are of two-letter combinations and three-letter combinations; and
validating the letter combinations based on a table of letter combination admissibility in a natural language style.

10. A system for lossless conversion of a PDF document to searchable PDF document, the system comprising:
at least one processor device, wherein the at least one processor device:
receives a PDF document having a potential first text layer;
performs an evaluation of quality of the potential first text layer, wherein if the potential first text layer does not exist or is not acceptable, a second text layer is generated for searching or copying.

11. The method of claim 10, wherein generating the second text layer comprises performing recognition of the document.

12. The method of claim 10 wherein the potential first text layer is not acceptable if it contains errors above a threshold.

13. The system of claim 10, wherein the first text layer is a visible text layer; and further wherein the at least one processor devices makes the visible text layer inaccessible for searching or copying.

14. The system of claim 10, wherein the first text layer is an invisible layer; and further wherein the at least one processor device removes the invisible text layer.

15. The system of claim 10, wherein the performing the evaluation of quality of the first text layer comprises comparing the first text layer with the second text layer.

16. The system of claim 15, wherein the at least one processor device, pursuant to comparing the first text layer to the second text layer, compares portions of the first text layer and the second text layer related to a same portion of the image.

17. The system of claim 10, wherein the at least one processor device, pursuant to performing the evaluation of quality of the first text layer, compares the first text layer against at least one dictionary to perform a dictionary validation operation.

18. The system of claim 10, wherein the at least one processor device, pursuant to performing the evaluation of quality of the first text layer, performs a Polygram method on the first text layer by:
dividing each word in the first text layer into letter combinations, where the letter combinations are of two-letter combinations and three-letter combinations; and
validating the letter combinations based on a table of letter combination admissibility in a natural language style.

19. A computer program product lossless conversion of a PDF document to searchable PDF document by a processor device, the computer program product comprising a non-transitory computer-readable storage medium having computer-readable program code portions stored therein, the computer-readable program code portions comprising:
a first executable portion that receives a PDF document having a potential first text layer;
a second executable portion that performs an evaluation of quality of the potential first text layer, wherein if the potential first text layer does not exist or not acceptable, a second text layer is generated for searching or copying.

20. The method of claim 19, wherein generating the second text layer comprises performing recognition of the document.

21. The method of claim 19, wherein the potential first text layer is not acceptable if it contains errors above a threshold.

22. The computer program product of claim 19, wherein the first text layer is a visible text layer; and further including a fifth executable portion that makes the visible text layer inaccessible for searching or copying.

23. The computer program product of claim 19, wherein the first text layer is an invisible layer; and further including a fifth executable portion that removes the invisible text layer.

24. The computer program product of claim 19 wherein the performing the evaluation of quality of the first text layer comprises comparing the first text layer to the second text layer.

25. The computer program product of claim 24, wherein the comparing the first text layer with the second text layer comprises comparing portions of the first text layer and the second text layer related to a same portion of the image.

26. The computer program product of claim 19, wherein the performing the evaluation of quality of the first text layer comprises comparing the first text layer against at least one dictionary to perform a dictionary validation operation.

27. The computer program product of claim 19, wherein performing the evaluation of quality of the first text layer further comprises performing a Polygram method on the first text layer by:
dividing each word in the first text layer into letter combinations, where the letter combinations are of two-letter combinations and three-letter combinations; and
validating the letter combinations based on a table of letter combination admissibility in a natural language style.
